(19) United States
(12) Patent Application Publication
(10) Pub. No.: US 2026/0051450 A1
(43) Pub. Date: Feb. 19, 2026

(54) FIRE PROTECTION FUSE AND VEHICLE ELECTRONIC CONTROL DEVICES INCLUDING THE SAME

(71) Applicant: HL MANDO CORPORATION, Pyeongtaek-si (KR)

(72) Inventor: Dongmin SON, Pyeongtaek-si (KR)

(73) Assignee: HL MANDO CORPORATION, Pyeongtaek-si (KR)

(21) Appl. No.: 19/066,565

(22) Filed: Feb. 28, 2025

(30) Foreign Application Priority Data
Aug. 13, 2024 (KR) 10-2024-0108056

(51) Int. Cl. H01H 85/046; H01H 37/74; H01H 85/048; H01H 85/055; H01H 85/143; H01H 85/20

(52) U.S. Cl. CPC H01H 85/046; H01H 37/74; H01H 85/048; H01H 85/055; H01H 85/143; H01H 85/20; H01H 2085/208

(57) ABSTRACT

A fire protection fuse of the present disclosure includes a substrate; a first resistance pad and a second resistance pad disposed spaced apart from each other on the substrate; a first wiring pattern and a second wiring pattern disposed on the substrate and connected to the first resistance pad and the second resistance pad, respectively; and a resistor connected to the first resistance pad and the second resistance pad, wherein at least one of the first wiring pattern and the second wiring pattern has at least one bottleneck section.

### CROSS-REFERENCE TO RELATED APPLICATION

This application claims priority to and the benefit from Korean Patent Application No. 10-2024-0108056, filed on Aug. 13, 2024, the disclosures of which are incorporated herein by reference in its entirety.

### BACKGROUND

The present disclosure relates to a fire protection fuse and a vehicle electronic control device including the same.

FIG. 1 is a circuit diagram of a conventional vehicle electronic control device.

As shown in FIG. 1, the conventional vehicle electronic control device includes a substrate 10 accommodated in a housing. Here, the substrate 10 is disposed standing on one side inside the housing.

The substrate 10 includes a thermal fuse 20, a diode 30, a power supply 40, and a ground pad 50.

The thermal fuse 20 and the diode 30 are connected between the first battery BAT1 and the power supply 40 through a wiring patterned on the substrate 10.

Similarly, the thermal fuse 20 and the diode 30 are connected between the second battery BAT2 and the power supply 40 through a wiring patterned on the substrate 10.

Here, the thermal fuse 20, the diode 30, and the power supply 40 may be disposed on the substrate 10.

Specifically, the thermal fuse 20 is connected between a battery 1 and the diode 30. Here, the thermal fuse 20 serves to cut off the electrical connection between the battery 1 and the power supply 40 when the temperature rises due to overcurrent.

In other words, the thermal fuse 20 is not opened by the flow of overcurrent itself, but is opened when the temperature is above a certain temperature (e.g., 300° C.).

The diode 30 is connected between the thermal fuse 20 and the power supply 40. Here, the diode 30 serves to prevent the current from flowing back from the power supply 40 to the battery 1 due to the reverse voltage.

The ground pad 50 is disposed on the substrate 10 and serves to provide ground to a conventional vehicle electronic control device.

The power supply 40 receives power from the battery 1 located outside the vehicle electronic control device.

When the conventional vehicle electronic control device is a device that controls the vehicle's braking device, the power supply 40 can supply power received from the battery 1 to a solenoid valve and a motor, etc.

Here, the solenoid valve serves to supply brake fluid pressure to the wheel cylinder, and the motor serves to pump the brake fluid and return it to the master cylinder or wheel cylinder.

The battery 1 is configured to include a first battery BAT1 and a second battery BAT2. Here, the second battery BAT2 is a redundancy battery for supplying power to the power supply 40 instead of the first battery BAT1 when the charging amount of the first battery BAT1 is insufficient.

The diode 30 and the ground pad 50 are disposed on the lower part of the substrate 10 in a state in which the substrate 10 stands.

As such, in the conventional vehicle electronic control device, since the substrate 10 is placed standing inside the housing, the lower part of the substrate 10 may be submerged due to moisture introduced into the housing, and in this case, a short-circuit occurs between the diode 30 and the ground pad 50 placed on the lower part of the substrate 10. In this case, since the ambient temperature of the thermal fuse 20 is about 220° C., the thermal fuse 20 is not opened.

Accordingly, in the conventional vehicle electronic control device, there is a risk of a short-circuit fire due to moisture inflow before the thermal fuse 20 is opened.

### SUMMARY

In order to solve the above-mentioned problems, the present disclosure is to prevent a fire by a process in which an overcurrent flows through a fire protection fuse made of a zero ohm resistor to open the resistor, when a short-circuit occurs between a diode and a ground pad due to moisture inflow.

In addition, the present disclosure is to prevent a short-circuit fire due to moisture inflow by forming a bottleneck section in a wiring pattern of the fire protection fuse to increasing the heating value to open the zero ohm resistor before the thermal fuse is opened.

The problems of the present disclosure are not limited to those mentioned above, and other problems not mentioned will be clearly understood by those of ordinary skill in the art from the following description.

In order to solve the above-mentioned problems, a fire protection fuse of the present disclosure includes a substrate; a first resistance pad and a second resistance pad disposed spaced apart from each other on the substrate; a first wiring pattern and a second wiring pattern disposed on the substrate and connected to the first resistance pad and the second resistance pad, respectively; and a resistor connected to the first resistance pad and the second resistance pad, wherein at least one of the first wiring pattern and the second wiring pattern has at least one bottleneck section.

The bottleneck section may be disposed around at least one of the first resistance pad and the second resistance pad.

At least one of the first wiring pattern and the second wiring pattern may surround at least one of the first resistance pad and the second resistance pad.

The bottleneck section may be formed in a bent shape in at least one of the first wiring pattern and the second wiring pattern.

The bottleneck section may have a smaller width than other sections of the first wiring pattern and the second wiring pattern.

The first wiring pattern may include a first extension pattern extending toward one side of the first resistance pad; and a first bottleneck pattern connected to the first extension pattern, surrounding the first resistance pad, and connected to one side of the first resistance pad.

The first bottleneck pattern may have a smaller width than that of the first extension pattern.

The second wiring pattern may include a second extension pattern extending toward one side of the second resistance pad; and a second bottleneck pattern connected to the second extension pattern, surrounding the second resistance pad, and connected to one side of the second resistance pad.

The second bottleneck pattern may have a width smaller than that of the second extension pattern.

The resistor may be a zero ohm resistor.

A vehicle electronic control device of the present disclosure includes a housing; a substrate accommodated in the housing; a first resistance pad and a second resistance pad disposed spaced apart from each other on the substrate; a first wiring pattern and a second wiring pattern disposed on the substrate and connected to the first resistance pad and the second resistance pad, respectively; and a resistor connected to the first resistance pad and the second resistance pad, wherein at least one of the first wiring pattern and the second wiring pattern has at least one bottleneck section.

The first resistance pad may be connected to a battery.

The vehicle electronic control device of the present disclosure may further include a thermal fuse disposed on the substrate and connected between the battery and the first resistance pad.

The vehicle electronic control device of the present disclosure may further include a diode disposed on the substrate and connected to the second resistance pad; a ground pad disposed on the substrate; and a power supply connected to the diode.

The substrate may be disposed standing in the housing, and the diode and the ground pad may be disposed at a lower part of the substrate.

The bottleneck section may be disposed around at least one of the first resistance pad and the second resistance pad.

At least one of the first wiring pattern and the second wiring pattern may surround at least one of the first resistance pad and the second resistance pad.

The bottleneck section may be formed in a bent shape in at least one of the first wiring pattern and the second wiring pattern.

The bottleneck section may have a smaller width than other sections of the first wiring pattern and the second wiring pattern.

The resistor may be a zero ohm resistor.

According to the present disclosure, it is possible to prevent a fire by a process in which an overcurrent flows through a fire protection fuse made of a zero ohm resistor to open the resistor, when a short-circuit occurs between a diode and a ground pad due to moisture inflow.

In addition, according to the present disclosure, it is possible to prevent a short-circuit fire due to moisture inflow by forming a bottleneck section in a wiring pattern of the fire protection fuse to increasing the heating value to open the zero ohm resistor before the thermal fuse is opened.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a circuit diagram of a conventional vehicle electronic control device;

FIG. 2 is a diagram schematically illustrating a vehicle electronic control device according to an exemplary embodiment of the present disclosure;

FIG. 3 is a circuit diagram of a vehicle electronic control device according to an exemplary embodiment of the present disclosure;

FIG. 4 is a diagram illustrating a fire protection fuse according to a first embodiment of the present disclosure;

FIG. 5 is a diagram illustrating a fire protection fuse according to a second embodiment of the present disclosure;

FIG. 6 is a diagram illustrating a fire protection fuse according to a third embodiment of the present disclosure; and

FIG. 7 is a diagram for describing an operation of a fire protection fuse according to an exemplary embodiment of the present disclosure.

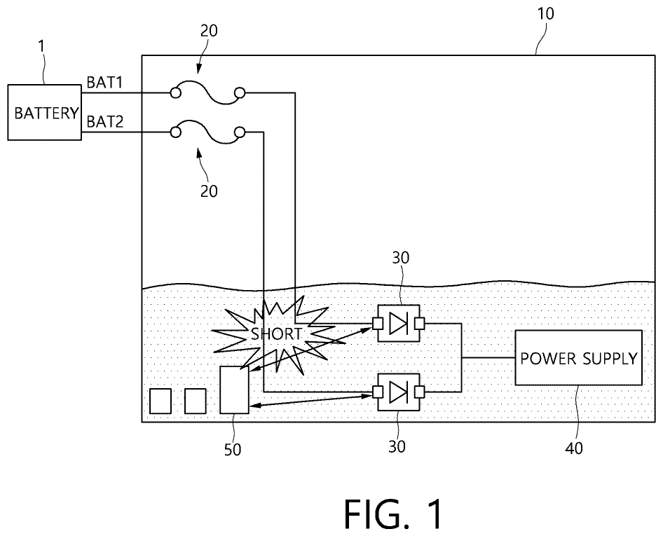

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

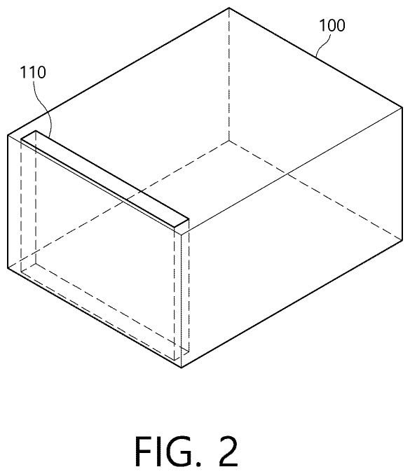

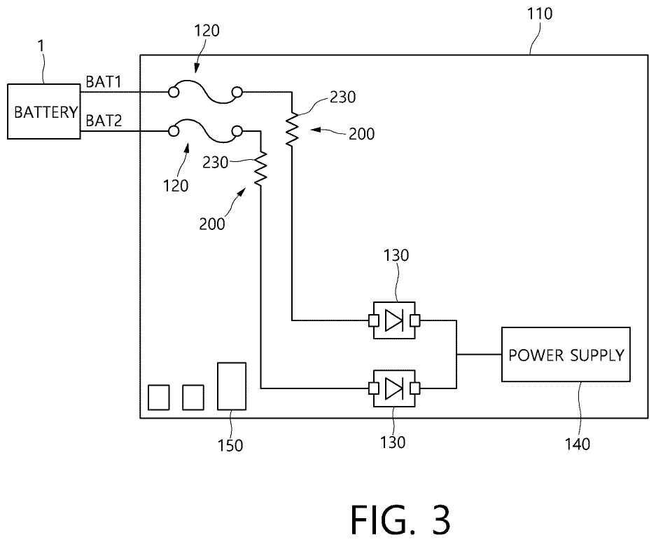

FIG. 2 is a diagram schematically illustrating a vehicle electronic control device according to an exemplary embodiment of the present disclosure, and FIG. 3 is a circuit diagram of a vehicle electronic control device according to an exemplary embodiment of the present disclosure.

As shown in FIG. 2, the vehicle electronic control device according to an exemplary embodiment of the present disclosure may be configured to include a housing 100 and a substrate 110 accommodated in the housing 100.

Here, the substrate 110 may be disposed standing on one side inside the housing 100.

The vehicle electronic control device according to an exemplary embodiment of the present disclosure may be a device for controlling a vehicle braking device, but is not limited thereto.

As shown in FIG. 3, the substrate 110 may be configured to include a thermal fuse 120, a fire protection fuse 200, a diode 130, a power supply 140, and a ground pad 150.

Here, the diode 130 and the ground pad 150 are disposed on the lower part of the substrate 110 in a state in which the substrate 110 stands.

Meanwhile, in the vehicle electronic control device according to an exemplary embodiment of the present disclosure, since the substrate 110 is placed standing inside the housing 100, the lower part of the substrate 110 may be submerged due to moisture introduced into the housing 100, and in this case, a short-circuit may occur between the diode 130 and the ground pad 150 placed on the lower part of the substrate 110.

The power supply 140 may receive power from a battery 1 located outside the vehicle electronic control device.

When the vehicle electronic control device according to an exemplary embodiment of the present disclosure is a device that controls the vehicle's braking device, the power supply 140 can supply power received from the battery 1 to a solenoid valve and a motor, etc.

Here, the solenoid valve serves to supply brake fluid pressure to the wheel cylinder, and the motor serves to pump the brake fluid and return it to the master cylinder or wheel cylinder.

The battery 1 may be configured to include a first battery BAT1 and a second battery BAT2. Here, the second battery BAT2 may be a redundancy battery for supplying power to the power supply 140 instead of the first battery BAT1 when the charging amount of the first battery BAT1 is insufficient.

In some cases, both the first battery BAT1 and the second battery BAT2 may supply power to the power supply 140.

Accordingly, the power supply 140 may include a switch for selecting at least one of the first battery BAT1 and the second battery BAT2 to select the power to be supplied.

The thermal fuse 120, the fire protection fuse 200, and the diode 130 may be connected between the first battery BAT1 and the power supply 140 through a wiring patterned on the substrate 110.

Similarly, the thermal fuse 120, the fire protection fuse 200, and the diode 130 may be connected between the second battery BAT2 and the power supply 140 through a wiring patterned on the substrate 110.

Here, the thermal fuse 120, the fire protection fuse 200, the diode 130, and the power supply 140 may be disposed on the substrate 110.

Specifically, the thermal fuse 120 is connected between the battery 1 and the fire protection fuse 200. Here, the thermal fuse 120 serves to cut off the electrical connection between the battery 1 and the power supply 140 when the temperature rises due to overcurrent.

In other words, the thermal fuse 120 is not opened by the flow of overcurrent itself, but is opened when the temperature is above a certain temperature (e.g., 300° C.).

The fire protection fuse 200 is connected between the thermal fuse 120 and the diode 130. Here, the fire protection fuse 200 may have a zero ohm resistor.

When a short-circuit occurs between the diode 130 and the ground pad 150 due to moisture introduced into the housing 100, the thermal fuse 120 is not opened because the ambient temperature of the thermal fuse 20 is about 220° C.

The fire protection fuse 200 serves to cut off the electrical connection between the battery 1 and the power supply 140 when a short-circuit between the diode 130 and the ground pad 150 occurs due to moisture introduced into the housing 100. This will be described in detail later.

The diode 130 is connected between the fire protection fuse 200 and the power supply 140. Here, the diode 130 serves to prevent the current from flowing back from the power supply 140 to the battery 1 due to the reverse voltage.

The ground pad 150 is disposed on the substrate 110 and serves to provide ground to the vehicle electronic control device.

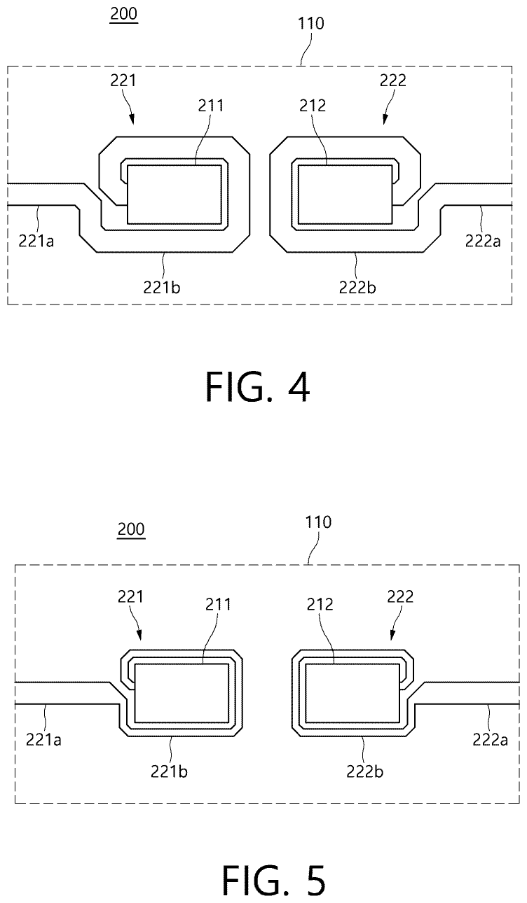

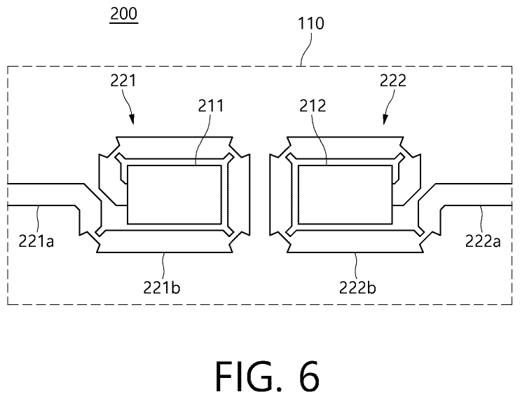

FIG. 4 is a diagram illustrating a fire protection fuse according to a first embodiment of the present disclosure, FIG. 5 is a diagram illustrating a fire protection fuse according to a second embodiment of the present disclosure, and FIG. 6 is a diagram illustrating a fire protection fuse according to a third embodiment of the present disclosure.

Referring to FIGS. 4 to 7, the fire protection fuse 200 according to the first to third embodiments of the present disclosure may be configured to include a substrate 110, a first resistance pad 211, a second resistance pad 212, a first wiring pattern 221, a second wiring pattern 222, and a resistor 230.

Here, the first resistance pad 211, the second resistance pad 212, the first wiring pattern 221, and the second wiring pattern 222 are made of a conductive material such as copper and gold, and may be formed on the substrate 110 by printing technology, plating technology, etching technology, and the like.

The first resistance pad 211 and the second resistance pad 212 may be formed in a quadrilateral shape, but are not limited thereto and may be formed in various shapes.

The first resistance pad 211, the second resistance pad 212, the first wiring pattern 221, and the second wiring pattern 222 may be integrally formed, but the present disclosure is not limited thereto, and the first wiring pattern 221 and the second wiring pattern 222 may be formed after the first resistance pad 211 and the second resistance pad 212 are formed first.

The resistor 230 may be mounted on the first resistance pad 211 and the second resistance pad 212 after the first resistance pad 211, the second resistance pad 212, the first wiring pattern 221, and the second wiring pattern 222 are formed.

The first resistance pad 211 and the second resistance pad 212 are disposed to be spaced apart from each other on the substrate 110. In addition, the first wiring pattern 221 and the second wiring pattern 222 are disposed on the substrate 110, and one end is connected to one side of the first resistance pad 211 and the second resistance pad 212, respectively.

Here, one side of the first resistance pad 211 is the closest part to the thermal fuse 120, and one side of the second resistance pad 212 is the closest part to the diode 120.

In addition, the other end of the first wiring pattern 221 is connected to the thermal fuse 120 through a wiring patterned on the substrate 110, and the other end of the second wiring pattern 222 is connected to the diode 130 through a wiring patterned on the substrate 110.

Both terminals of the resistor 230 are mounted on the first resistance pad 211 and the second resistance pad 212, respectively. Accordingly, the resistor 230 is electrically connected to the first resistance pad 211 and the second resistance pad 212.

The resistor 230 may be a zero ohm resistor, and may be opened when a short-circuit occurs between the diode 130 and the ground pad 150 disposed on the lower part of the substrate 110 due to moisture inflow.

Here, the zero ohm resistor is a resistor used as a jumper and a fuse, and the actual resistance value of the zero ohm resistor may be several tens of ohms, and the rated current may be selected as 2 A in consideration of the rated current of the power supply 140 being 500 mA.

Meanwhile, as a result of current level evaluation by forming the first wiring pattern 221 and the second wiring pattern 222 in a straight line, it was confirmed that the resistor 230 was opened after 35 minutes at 6 A under 125° C. conditions. This means that there is a possibility of fire before the resistor 230 is opened.

Therefore, it is necessary to open the resistor 230 at lower current and temperature by increasing the heating value.

To this end, the fire protection fuse 200 according to the first to third embodiments of the present disclosure is characterized in that at least one of the first wiring pattern 221 and the second wiring pattern 222 includes at least one bottleneck section.

Here, the bottleneck section may be disposed around at least one of the first resistance pad 211 and the second resistance pad 212.

In addition, the bottleneck section may be formed in a bent shape in at least one of the first wiring pattern 221 and the second wiring pattern 222.

As such, since the fire protection fuse 200 according to an exemplary embodiment of the present disclosure has a shape in which the bottleneck section is bent, the resistance value increases and the heating value may increase.

Accordingly, the fire protection fuse 200 according to an exemplary embodiment of the present disclosure can prevent a fire by opening the resistor 230 at a lower temperature and current than when the first wiring pattern 221 and the second wiring pattern 222 are formed in a straight line when a short-circuit occurs between the diode 130 and the ground pad 150 due to moisture inflow.

In addition, the bottleneck section may have a smaller width than other sections of the first wiring pattern 221 and the second wiring pattern 222.

As such, in the fire protection fuse 200 according to an exemplary embodiment of the present disclosure, since the width of the bottleneck section has a smaller width than that of the other sections, the resistance value may increase and the heating value may increase.

Accordingly, the fire protection fuse 200 according to an exemplary embodiment of the present disclosure can prevent a fire by opening the resistor 230 at a lower temperature and current than when the widths of the first wiring pattern 221 and the second wiring pattern 222 are uniformly formed when a short-circuit occurs between the diode 130 and the ground pad 150 due to moisture inflow.

At least one of the first wiring pattern 221 and the second wiring pattern 222 may surround at least one of the first resistance pad 211 and the second resistance pad 212.

As such, the fire protection fuse 200 according to an exemplary embodiment of the present disclosure may form a plurality of bent bottleneck sections around at least one of the first resistance pad 211 and the second resistance pad 212 by arranging at least one of the first wiring pattern 221 and the second wiring pattern 222 to surround at least one of the first resistance pad 211 and the second resistance pad 212.

Accordingly, when a short-circuit occurs between the diode 130 and the ground pad 150 due to moisture inflow, the fire protection fuse 200 according to an exemplary embodiment of the present disclosure can prevent a fire by increasing the heating value around at least one of the first wiring pattern 221 and the second wiring pattern 222 to open the resistor 230 at a lower temperature and current.

The first wiring pattern 221 may be configured to include a first extension pattern 221a and a first bottleneck pattern 221b.

The first extension pattern 221a extends toward one side of the first resistance pad 211, and the first bottleneck pattern 221b is connected to the first extension pattern 221a, surrounds the first resistance pad 211, and is connected to one side of the first resistance pad 211. Here, one side of the first resistance pad 211 is a portion closest to the thermal fuse 120.

The first bottleneck pattern 221b may have a width smaller than that of the first extension pattern 221a.

The second wiring pattern 222 may be configured to include a second extension pattern 222a and a second bottleneck pattern 222b.

The second extension pattern 222a extends toward one side of the second resistance pad 212, and the second bottleneck pattern 222b is connected to the second extension pattern 222a, surrounds the second resistance pad 212, and is connected to one side of the second resistance pad 212.

Here, one side of the second resistance pad 212 is a portion closest to the diode 120.

The second bottleneck pattern 222b may have a width smaller than that of the second extension pattern 222a.

As shown in FIG. 4, in the fire protection fuse 200 according to the first embodiment of the present disclosure, the first wiring pattern 221 may surround the first resistance pad 211, and the second wiring pattern 222 may surround the second resistance pad 212.

Here, widths of the first wiring pattern 221 and the second wiring pattern 222 may be formed to be constant.

As such, the fire protection fuse 200 according to the first embodiment of the present disclosure may form a plurality of bent bottleneck sections around the first resistance pad 211 and the second resistance pad 212 by arranging the first wiring pattern 221 and the second wiring pattern 222 to surround the first resistance pad 211 and the second resistance pad 212, respectively.

Accordingly, when a short-circuit occurs between the diode 130 and the ground pad 150 due to moisture inflow, the fire protection fuse 200 according to the first embodiment of the present disclosure can prevent a fire by increasing the heating value around the first wiring pattern 221 and the second wiring pattern 222 to open the resistor 230 at a lower temperature and current.

On the other hand, the fire protection fuse 200 according to the first embodiment of the present disclosure may be arranged so that only one of the first wiring pattern 221 and the second wiring pattern 222 surrounds the first resistance pad 211 or the second resistance pad 212.

For example, the first wiring pattern 221 may be arranged to surround the first resistance pad 211, and the second wiring pattern 222 may be arranged to be connected to one side of the second resistance pad 212 in a straight line.

In addition, the fire protection fuse 200 according to the first embodiment of the present disclosure may be arranged so that the first wiring pattern 221 and the second wiring pattern 222 surround the first resistance pad 211 and the second resistance pad 212 two times or more, respectively.

As shown in FIG. 5, unlike the first embodiment, the fire protection fuse 200 according to the second embodiment of the present disclosure may be formed such that widths of the first wiring pattern 221 and the second wiring pattern 222 are not constant.

Specifically, the first bottleneck pattern 221b may be formed to have a smaller width than the first extension pattern 221a, and the second bottleneck pattern 222b may be formed to have a smaller width than the second extension pattern 222a. Here, the first bottleneck pattern 221b and the second bottleneck pattern 222b may be formed to have a constant width, and the first extension pattern 221a and the second extension pattern 222a may be formed to have a constant width.

As such, the fire protection fuse 200 according to the second embodiment of the present disclosure may increase the resistance of the first bottleneck pattern 221b and the second bottleneck pattern 222b compared to the first embodiment by forming the widths of the first bottleneck pattern 221b and the second bottleneck pattern 222b smaller than that of the first embodiment.

Accordingly, when a short-circuit occurs between the diode 130 and the ground pad 150 due to moisture inflow, the fire protection fuse 200 according to the second embodiment of the present disclosure can prevent a fire by increasing the heating value around the first bottleneck pattern 221b and the second bottleneck pattern 222b compared to the first embodiment to open the resistor 230 at a lower temperature and current.

On the other hand, the fire protection fuse 200 according to the second embodiment of the present disclosure may be arranged so that only one of the first wiring pattern 221 and the second wiring pattern 222 surrounds the first resistance pad 211 or the second resistance pad 212.

For example, the first wiring pattern 221 may be arranged to surround the first resistance pad 211, and the second wiring pattern 222 may be arranged to be connected to one side of the second resistance pad 212 in a straight line.

In addition, the fire protection fuse 200 according to the second embodiment of the present disclosure may be arranged so that the first wiring pattern 221 and the second wiring pattern 222 surround the first resistance pad 211 and the second resistance pad 212 two times or more, respectively.

As shown in FIG. 6, unlike the first embodiment, the fire protection fuse 200 according to the third embodiment of the present disclosure may be formed such that widths of the first wiring pattern 221 and the second wiring pattern 222 are not constant.

Specifically, the bent portion of the first bottleneck pattern 221b may be formed to have a smaller width than other portions, and the bent portion of the second bottleneck pattern 222b may be formed to have a smaller width than other portions. Here, the first extension pattern 221a and the second extension pattern 222a, and portions of the first bottleneck pattern 221b and the second bottleneck pattern 222b other than the bent portions may be formed to have a constant width.

As such, the fire protection fuse 200 according to the third embodiment of the present disclosure may increase the resistance of the bent portions of the first bottleneck pattern 221b and the second bottleneck pattern 222b compared to the first embodiment by forming the widths of the bent portions of the first bottleneck pattern 221b and the second bottleneck pattern 222b smaller than that of the first embodiment.

Accordingly, when a short-circuit occurs between the diode 130 and the ground pad 150 due to moisture inflow, the fire protection fuse 200 according to the third embodiment of the present disclosure can prevent a fire by increasing the heating value of the bent portions of the first bottleneck pattern 221b and the second bottleneck pattern 222b compared to the first embodiment to open the resistor 230 at a lower temperature and current.

On the other hand, the fire protection fuse 200 according to the third embodiment of the present disclosure may be arranged so that only one of the first wiring pattern 221 and the second wiring pattern 222 surrounds the first resistance pad 211 or the second resistance pad 212.

For example, the first wiring pattern 221 may be arranged to surround the first resistance pad 211, and the second wiring pattern 222 may be arranged to be connected to one side of the second resistance pad 212 in a straight line.

In addition, the fire protection fuse 200 according to the third embodiment of the present disclosure may be arranged so that the first wiring pattern 221 and the second wiring pattern 222 surround the first resistance pad 211 and the second resistance pad 212 two times or more, respectively.

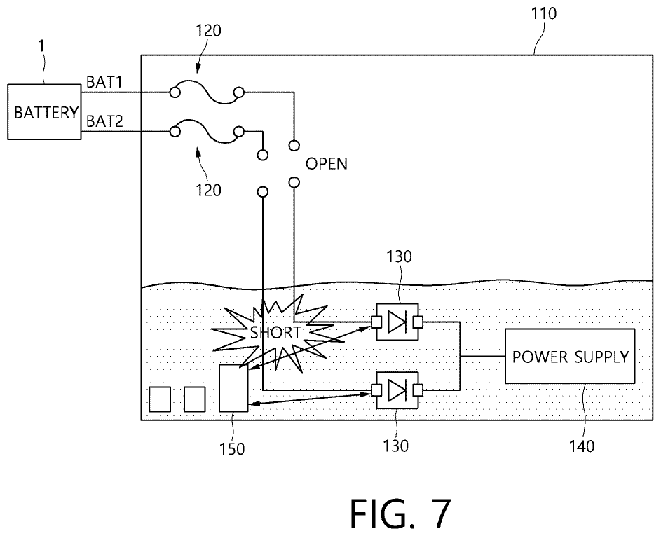

FIG. 7 is a diagram for describing an operation of a fire protection fuse according to an exemplary embodiment of the present disclosure.

In the vehicle electronic control device according to an exemplary embodiment of the present disclosure, since the substrate 110 is placed standing inside the housing 100, the lower part of the substrate 110 may be submerged due to moisture introduced into the housing 100, and in this case, a short-circuit may occur between the diode 130 and the ground pad 150 placed on the lower part of the substrate 110.

As such, when a short-circuit occurs between the diode 130 and the ground pad 150 due to moisture inflow, the fire protection fuse 200 according to an exemplary embodiment of the present disclosure may prevent a fire by flowing an overcurrent to the fire protection fuse 200 to open the resistor 230.

In particular, the fire protection fuse 200 according to an exemplary embodiment of the present disclosure increases the heating value by forming a bottleneck section in the first wiring pattern 221 and the second wiring pattern 222, thereby preventing a short-circuit fire due to moisture inflow by opening the resistor 230 before the thermal fuse 120 is opened.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A fire protection fuse, the fuse comprising:
a substrate;
a first resistance pad and a second resistance pad disposed on the substrate;
a first wiring pattern and a second wiring pattern disposed on the substrate and connected to the first resistance pad and the second resistance pad; and
a resistor connected to the first resistance pad and the second resistance pad,
wherein at least one of the first wiring pattern or the second wiring pattern has at least one bottleneck section.

2. The fuse of claim 1, wherein the bottleneck section is disposed around at least one of the first resistance pad or the second resistance pad.

3. The fuse of claim 1, wherein at least one of the first wiring pattern or the second wiring pattern covering at least one of the first resistance pad or the second resistance pad.

4. The fuse of claim 1, wherein the bottleneck section is disposed in a bent shape in at least one of the first wiring pattern or the second wiring pattern.

5. The fuse of claim 1, wherein the bottleneck section is configured with a smaller width than other sections of the first wiring pattern and the second wiring pattern.

6. The fuse of claim 1, wherein the first wiring pattern comprises:
a first extension pattern extending toward one side of the first resistance pad; and
a first bottleneck pattern connected to the first extension pattern, covering the first resistance pad, and connected to one side of the first resistance pad.

7. The fuse of claim 6, wherein the first bottleneck pattern is configured with a smaller width than the first extension pattern.

8. The fuse of claim 6, wherein the second wiring pattern comprises:
a second extension pattern extending toward one side of the second resistance pad; and
a second bottleneck pattern connected to the second extension pattern, covering the second resistance pad, and connected to one side of the second resistance pad.

9. The fuse of claim 8, wherein the second bottleneck pattern is configured with a smaller width than the second extension pattern.

10. The fuse of claim 1, wherein the resistor is configured with a zero ohm resistor.

11. A vehicle electronic control device, the device comprising:
a housing;
a substrate disposed in the housing;
a first resistance pad and a second resistance pad disposed on the substrate;
a first wiring pattern and a second wiring pattern disposed on the substrate and connected to the first resistance pad and the second resistance pad; and
a resistor connected to the first resistance pad and the second resistance pad,
wherein at least one of the first wiring pattern or the second wiring pattern has at least one bottleneck section.

12. The device of claim 11, wherein the first resistance pad is connected to a battery.

13. The device of claim 12, further comprising:
a thermal fuse disposed on the substrate and connected between the battery and the first resistance pad.

14. The device of claim 11, further comprising:
a diode disposed on the substrate and connected to the second resistance pad;
a ground pad disposed on the substrate; and
a power supply connected to the diode.

15. The device of claim 14,
wherein the substrate is disposed standing in the housing, and
wherein the diode and the ground pad are disposed at a lower part of the substrate.

16. The device of claim 11, wherein the bottleneck section is disposed around at least one of the first resistance pad or the second resistance pad.

17. The device of claim 11, wherein at least one of the first wiring pattern or the second wiring pattern covering at least one of the first resistance pad or the second resistance pad.

18. The device of claim 11, wherein the bottleneck section is disposed in a bent shape in at least one of the first wiring pattern or the second wiring pattern.

19. The device of claim 11, wherein the bottleneck section is configured with a smaller width than other sections of the first wiring pattern and the second wiring pattern.

20. The device of claim 11, wherein the resistor is configured with a zero ohm resistor.
